(19) United States
(12) Patent Application Publication
(10) Pub. No.: US 2025/0131314 A1
(43) Pub. Date: Apr. 24, 2025

(54) SOLVING PROBLEMS WITH QUANTUM ANNEALING AND PATTERN MINING

(71) Applicant: Dell Products L.P., Round Rock, TX (US)

(72) Inventors: Ítalo Gomes Santana, Rio de Janeiro (BR); Diego Vrague Noble, Pelotas (BR); Miguel Paredes Quiñones, Campinas (BR)

(21) Appl. No.: 18/491,122

(22) Filed: Oct. 20, 2023

(51) Int. Cl. G06F 18/26; G06N 10/60

(52) U.S. Cl. CPC G06N 10/60

(57) ABSTRACT

Systems and methods for solving problems including combinatorial optimization problems are disclosed. A set of solutions to a combinatorial optimization problem are obtained from a quantum computing system such as a quantum annealer. A pattern mining operation is performed on a set of solutions output by a quantum annealing. The patterns are input to a solver to generate a solution to the initial problem.

### FIELD OF THE INVENTION

Embodiments of the present invention generally relate to solving problems using quantum computing and classical computing. More particularly, at least some embodiments of the invention relate to systems, hardware, software, computer-readable media, and methods for solving problems using both quantum annealing, pattern mining, and classical computing.

### BACKGROUND

Quantum annealing is a physical process that uses quantum fluctuations to solve hard combinatorial optimization problems (COP). One of the benefits of quantum annealing is its ability to identify a pool of potential solutions for a combinatorial optimization problem. However, the overall quality of the solutions obtained from the quantum annealer may be suboptimal. More specifically, solving a combinatorial optimization problem with a quantum annealer includes generating a Hamiltonian defined over a set of weights. However, determining a good set is itself a combinatorial optimization problem. Thus, making the overall optimization process using quantum annealing complicated and time consuming.

Heuristics in classical computing systems may also be used to find a solution to a combinatorial optimization problem. However, using heuristics may require a tradeoff between solution quality and execution time. This trade off may be acceptable in many instances. Solving a combinatorial optimization problem using heuristics often starts with a random solution. Unfortunately, the search process of a heuristic approach may be compromised when the initial solution is of low quality. A low quality initial solution may prevent the search from converging to a high-quality solution in the search space. This drawback is particularly significant in large-scale problems and in problems whose objective functions are complex (e.g., high correlations among terms or complicated mathematical functions) and in problems with large numbers of variables.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered limiting of its scope, embodiments of the invention will be described and explained with additional specificity and detail through the use of the accompanying drawings, in which:

FIG. 1 discloses aspects of a computing system or environment in which problems such as combinatorial optimization problems are solved;

FIG. 2A discloses aspects of a method for solving problems including combinatorial optimization problems;

FIG. 2B discloses additional aspects of a method for solving combinatorial optimization problems including pattern extraction;

FIG. 3 discloses further aspects of an example method for solving combinatorial optimization problems; and

FIG. 4 discloses aspects of a computing device, system, or entity.

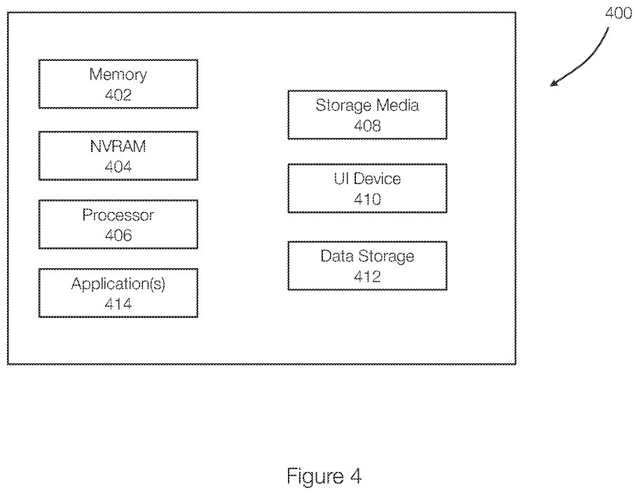

### DETAILED DESCRIPTION OF SOME EXAMPLE EMBODIMENTS

Embodiments of the present invention generally relate to solving problems including combinatorial optimization problems (COPs). More particularly, at least some embodiments of the invention relate to systems, hardware, software, computer-readable media, and methods for solving combinatorial optimization problems using quantum computing and classical computing systems.

Embodiments of the invention relate to solving problems, such as combinatorial optimization problem, using a combination of a quantum processing unit (e.g., a quantum annealer) and classical computing systems (e.g., CPU (Central Processing Unit), GPU (Graphical Processing Unit), processors, memory) to find high quality solutions for combinatorial optimization problems. In example embodiments, a pool of solutions may be generated by a quantum annealer (or other quantum system). Next, a data mining is performed to extract patterns from the pool of solutions. The patterns extracted from the pool of solutions, or itemsets, are used to find a solution using classical computing systems.

More specifically, embodiments of the invention allow routines that generate random initial solutions to solve combinatorial optimization problems to be improved or replaced with solutions that are guided by patterns that were extracted from the output of a quantum system and/or configured to fix decision variables in exact solvers and quantum annealers. Embodiments of the invention are scalable to larger instances at least because the patterns can reduce the original instance size of the combinatorial optimization problem for classical solvers.

Embodiments of the invention reduce the overall computational burden of solving combinatorial optimization problems using patterns to guide a search starting from a pool of solutions identified by a quantum computing system.

Generally, example embodiments identify or find a pool of solutions using a quantum annealing system, processing the pool of solutions to identify patterns in the solutions, and solving the problem in classical computing using the patterns extracted from the pool of solutions to find a solution to the combinatorial optimization problem.

In one example, I is a problem instance of a combinatorial optimization problem (e.g., a NP-hard problem, an example of which is Traveling Salesperson Problem). Initially, I is solved on a quantum annealer, which returns a pool of many low-energy states for I. The pool of low-energy states represents or corresponds to a pool of potential solutions to the problem instance I. The size of the pool of solutions can be manually calibrated by the number of reads. In one example, the size of the pool is proportional to the number of reads (e.g., 1:1). The pool of solutions may include, by way of example, thousands of solutions to the combinatorial optimization problem.

The pool of solutions, which can be viewed as a transactional dataset, is subject to a pattern mining operation to identify hidden structures as patterns. A mined pattern, in one example, is a composition of common occurrences of solution parts that are not necessarily consecutive in the dataset.

Some solution parts may be discarded in the search process performed by a solver S (e.g., a classical computing system) when solving I. The inclusion of patterns into the solver S focuses on solution parts that are harder or more complex.

Embodiments of the invention may be implemented with a wide variety of solvers or heuristics, which allows various weaknesses to be circumvented. In classical solvers, such as heuristics, for example, the need to generate a large pool of solutions is avoided and is performed in a quantum computing system.

Quantum annealers are able to generate many low-energy states (i.e., problem solutions to a given instance) quickly. This occurs by embedding the original input graph into physical qubits entangled in the quantum hardware, transforming the input graph into one that is subject to the real entanglement of the qubits. Once the input graph is embedded, a solution (i.e., a sample) can be quickly drawn from the embedded graph by leveraging the quantum dynamics on the hardware components. Unlike classical solvers, increasing the size of the input graph theoretically does not exponentially increase the time needed to solve larger input instances in quantum annealers. As a result, sampling large sets of solutions on quantum annealers becomes extremely fast compared to classical computing.

Embodiments of the invention perform pattern extraction operations on a set or pool of solutions identified or generated by a quantum system such as a quantum annealer. Using patterns extracted from a pool of solutions allows classical solvers to converge on solutions more quickly. Exact solving techniques and heuristic solving techniques can simultaneously leverage the patterns to reduce a search space (using variable fixation) or to provide pattern-based initial solutions for their search process.

Pattern mining may be performed to find common structures in transactional datasets. Given the exponential number of possible patterns that can be mined, patterns are usually related with their appearance (frequent patterns) in the target database. One common metric to define or determine if a pattern is frequent is called minimum support, which measures the minimum appearance of a pattern in all transactions of the dataset. On datasets that May contain similar transactions, many patterns can exist even on higher values for their minimum support. To reduce this redundancy, maximal frequent patterns may be mined instead. A frequent pattern is maximal if the pattern is frequent and there is no frequent super pattern that contains the pattern. Apriori is an example of an algorithm employed to mine patterns. However, Apriori can require longer running times for datasets with a large number of unique items. In one example, FP-Max and FP-Growth may be used to perform the data mining task.

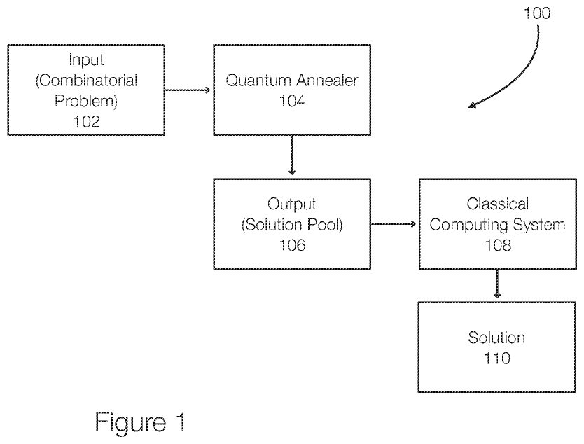

FIG. 1 discloses aspects of an environment or system for solving problems such as combinatorial optimization problems. The system 100 include a quantum annealer 104, which is an example of a quantum computing system and which may be real or virtual. The system 100 also includes a classical computing system 108, which includes processors, memory, networking hardware, or the like.

An input 102 is prepared and provided to the quantum annealer 104. The input 102 may correspond to a combinatorial optimization problem that is presented in the appropriate form to the quantum annealer 104, such as a QUBO (Quadratic Unconstrained Binary Optimization). A QUBO mathematically defines an optimization problem using binary variables. The quantum annealer 104 requires decision variables to have one of two possible states and the QUBO format is therefore suitable for the quantum annealer 104.

The quantum annealer 104 receives the input 102 and generates an output 106. In one example, the output is a pool of solutions to the input 102 (e.g., a combinatorial optimization problem). The output 106 is input to a classical computing system 108, which generates a solution 110. The solution may include a specific solution to the combinatorial optimization problem that may or may not be in the pool of solutions. In one example, the classical computing system 108 may identify patterns in the output 106 by performing a mining operation and use the patterns extracted from the pool of solutions to perform a focused search in the solution space.

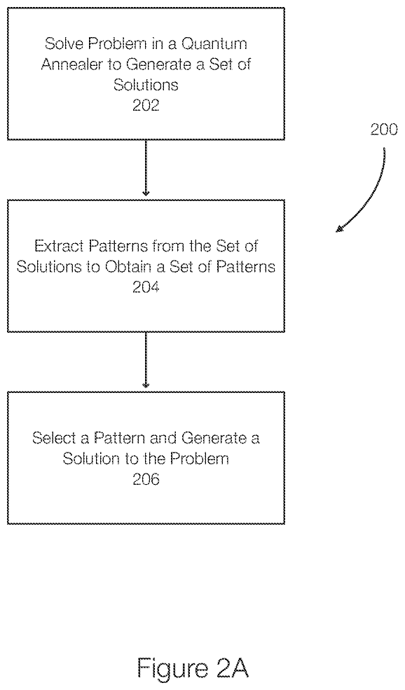

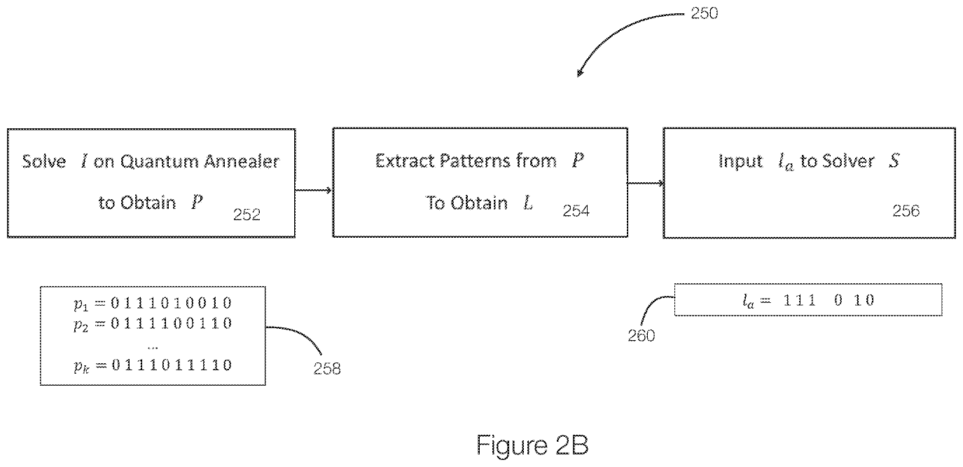

FIG. 2A discloses aspects of a method for finding a solution or solutions to a problem such as a combinatorial optimization problem. FIG. 2A illustrates an example of solving I, which is a problem instance of combinatorial optimization problem. The problem is solved using a quantum annealer (or multiple quantum annealers if necessary) to generate a pool of solution P. A pattern mining operation is then performed to extract patterns from P. These patterns serve as input to a solver for finding a final solution to I.

The method 200 thus includes solving 202 a problem instance in a quantum annealer to generate a set or pool of solutions. More specifically, I is solved on a quantum annealer to obtain a pool of solutions P={p₁, p₂, . . . , pₖ}. This may be performed by defining the combinatorial optimization in a QUBO format and submitting the combinatorial optimization problem in QUBO format and the problem instance/to the quantum annealer. In one example, to obtain a diversified and large P, different parameters or hyperparameters may be set or adopted (e.g., number of sweeps, number of reads, beta) on multiple runs.

The method 200 then extracts 204 patterns L={l₁, l₂, . . . , lₖ} from P. Because the number of patterns can be exponential based on the size of P and because P may have deteriorated solutions, the quality of L can be improved by first selecting the most effective solutions of P according to a quality measure, such as the cost value or energy level given by the quantum annealer. Next, a minimum support for patterns that are mined from the pool of solutions may be determined. This may improve the quality of the patterns L. In addition, to reduce the number of patterns and avoid redundancy, embodiments of the invention may mine maximal frequent patterns.

Next a pattern (lₐ∈L) is selected and its elements are used as input along with the problem instance I to a classical solver S or computing system and a quality solution of I is obtained as the output of the classical solver. The selection of the pattern lₐ can be random, based on a policy, and/or based on user-defined criterion.

FIG. 2B discloses additional aspects of solving a combinatorial optimization problem. In the method 250, a problem instance of a combinatorial optimization problem I is solved on a quantum annealer to obtain a pool or set of solutions P. FIG. 2B illustrates a set of solutions 258. Next, patterns are extracted 254 from the set of solutions 258 to obtain a set of patterns L. A selected pattern lₐ260 is input to a solver S 256 and a solution is generated.

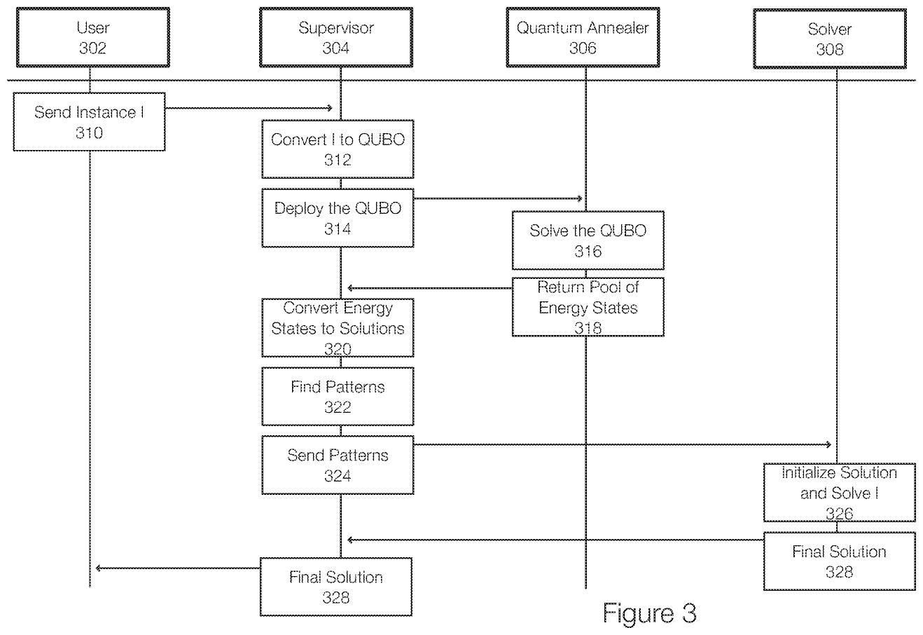

FIG. 3 discloses additional aspects of a method for solving a problem such as a combinatorial optimization problem. FIG. 3 illustrates a user 302 (e.g., an application, a user, a client, an application, or device (real or virtual)) that requests optimization of a problem instance I. Thus, the problem instance 310 is sent to a supervisor 304. The supervisor may be a central server. The supervisor 304 converts 312 the problem instance to QUBO format (or other appropriate format such as Ising). The supervisor 304 may deploy QUBO 314 to a quantum annealer 306. The quantum annealer 306 solves 316 the QUBO and returns 318 a pool energy states to the supervisor 304. The supervisor 304 converts 320 the energy states to solutions. This results in a pool or set of solutions.

The supervisor may perform a pattern mining operation on the solutions returned from the quantum annealer 306 to find patterns 322 in the set of solutions. The patterns are sent 324 by the supervisor 304 to a solver 308 (e.g., executing in classical computing systems). The solver 308 may initialize the heuristic operation or other solving techniques or other operations and solve 326 the problem instance based on the patterns. The final solution 328 is returned to the supervisor 304 and/or the user 302.

The supervisor 304, the quantum annealer solver 306, and the solver 308 may be implemented logically or physically. These may be services in a cloud service, monolithic applications on a single machine, quantum devices, or the like.

The solver 308 may include one or more of heuristics, exact solvers, and/or quantum annealers. In these implementations, embodiments of the invention focus on promising regions of the search of solutions (local search).

When the solver 308 is a heuristic solver, patterns may be included or processed in different manners. For example, an attempt to reduce I according to lₐ ∈L may be performed. In one example, solution parts are simply removed from I, creating a reduced version of/as illustrated in the selected pattern 260 in FIG. 2B. For example, consider a sequence of visited cities that appears in an lₐ of many TSP (Traveling Salesman Problem) solutions (common parts). Embodiments of the invention may consider only the initial and the final cities of this sequence in I while removing all intermediate cities of this sequence in I, in this way reducing the size of I.

In another example, an initial solution may be generated that is configured to act as a warm start solution (e.g., a high-quality initial solution for the optimization process) instead of reducing the size of I. Considering the TSP example, all sequences of cities from lₐ are introduced into an empty initial solution, which is completed using the remaining cities. A procedure to generate such a solution may include a random-greedy component that introduces a sequence of cities followed by a random city. In this case, if a selected random city belongs to another sequence of cities from lₐ, the whole sequence is introduced instead. This process is repeated until all cities are included in the resulting solution.

In the context of genetic programming algorithms, an entire population may be initialized by selecting patterns from L and applying the latter procedure. In these examples, the solver will focus the search effort on solution parts that were not present in the pattern, which are likely hard to solve once they did not appear in lₐ.

In exact solvers and quantum annealing solvers, the input of pattern information is done straightforwardly rather than heuristically. A pattern to fix decision variables can be selected in an exact solver. This reduces the search space of solutions by making the solver focus on the non-fixed variables. The same actions can be applied to quantum annealing solvers, because quantum annealer solvers also accept fixing decision variables before running.

It is noted that embodiments of the invention, whether claimed or not, cannot be performed, practically or otherwise, in the mind of a human (e.g., too many solutions to test). Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, quantum annealing operations, heuristic operations, exact solver operations, pattern mining operations, pattern selection operations, combinatorial optimization problem solving operations, and the like or combinations thereof. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform various operations, including those described herein, which are initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VM)

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, servers, and clients, for example, may likewise take the form of software, physical machines, containers, or virtual machines (VM), though no particular component implementation is required for any embodiment.

Example embodiments of the invention are applicable to any system capable of storing and handling various types of data or objects, in analog, digital, or other form.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method, comprising: generating a pool of solutions to a problem by a quantum computing system, performing pattern mining extraction on the pool of solutions to generate a set of patterns, and inputting the set of patterns to a classical solver, wherein the classical solver generates and outputs a solution to the problem.

Embodiment 2. The method of embodiment 1, further comprising receiving the problem at the quantum computing system, wherein the quantum computing system comprises a quantum annealer and the problem comprises a combinatorial optimization problem in a format configured for the quantum annealer.

Embodiment 3. The method of embodiment 1 and/or 2, further comprising converting the combinatorial optimization problem to a QUBO format.

Embodiment 4. The method of embodiment 1, 2, and/or 3, wherein the pool of solutions from the quantum annealer comprise energy states that are converted to solutions.

Embodiment 5. The method of embodiment 1, 2, 3, and/or 4, further comprising selecting the patterns from a reduced pool of solutions, wherein the pool of solutions is reduced based on solution cost value or energy level or wherein the pool of solutions is reduced using Maximal frequent patterns.

Embodiment 6. The method of embodiment 1, 2, 3, 4, and/or 5, further comprising reducing a number of the patterns based on a minimum support value or by mining maximum frequent patterns.

Embodiment 7. The method of embodiment 1, 2, 3, 4, 5, and/or 6, wherein the classical solver comprises a heuristic solver.

Embodiment 8. The method of embodiment 1, 2, 3, 4, 5, 6, and/or 7, further comprising removing certain solution parts from the patterns.

Embodiment 9. The method of embodiment 1, 2, 3, 4, 5, 6, 7, and/or 8, wherein the classical solver comprises an exact solver.

Embodiment 10. The method of embodiment 1, 2, 3, 4, 5, 6, 7, 8, and/or 9, further comprising fixing decision variables in the patterns such that search is focused on solution parts that are not present in the patterns.

Embodiment 11. The method as recited in any of embodiments 1-10 or any combinations of portions thereof.

Embodiment 12 A system, comprising hardware and/or software, operable to perform any of the operations, methods, or processes, or any portion of any of these, disclosed herein.

Embodiment 13 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, engine, service, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

With reference briefly now to FIG. 7, any one or more of the entities disclosed, or implied, by the Figures, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein. The device 700 may alternatively represent an edge system, a cloud system/service, a distributed system, or the like.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
generating a pool of solutions to a problem by a quantum computing system;
performing pattern mining extraction on the pool of solutions to generate a set of patterns;
inputting the set of patterns to a classical solver, wherein the classical solver generates and outputs a solution to the problem.

2. The method of claim 1, further comprising receiving the problem at the quantum computing system, wherein the quantum computing system comprises a quantum annealer and the problem comprises a combinatorial optimization problem in a format configured for the quantum annealer.

3. The method of claim 2, further comprising converting the combinatorial optimization problem to a QUBO format.

4. The method of claim 2, wherein the pool of solutions from the quantum annealer comprise energy states that are converted to solutions.

5. The method of claim 2, further comprising selecting the patterns from a reduced pool of solutions, wherein the pool of solutions is reduced based on solution cost value or energy level or wherein the pool of solutions is reduced using Maximal frequent patterns.

6. The method of claim 1, further comprising reducing a number of the patterns based on a minimum support value or by mining maximum frequent patterns.

7. The method of claim 1, wherein the classical solver comprises a heuristic solver.

8. The method of claim 7, further comprising removing certain solution parts from the patterns.

9. The method of claim 1, wherein the classical solver comprises an exact solver.

10. The method of claim 9, further comprising fixing decision variables in the patterns such that search is focused on solution parts that are not present in the patterns.

11. A non-transitory storage medium having stored therein instructions that are executable by one or more hardware processors to perform operations comprising:
generating a pool of solutions to a problem by a quantum computing system;
performing pattern mining extraction on the pool of solutions to generate a set of patterns;
inputting the set of patterns to a classical solver, wherein the solver generates and outputs a solution to the problem.

12. The non-transitory storage medium of claim 11, further comprising receiving the problem at the quantum computing system, wherein the quantum computing system comprises a quantum annealer and the problem comprises a combinatorial optimization problem in a format configured for the quantum annealer.

13. The non-transitory storage medium of claim 12, further comprising converting the combinatorial optimization problem to a QUBO format.

14. The non-transitory storage medium of claim 12, wherein the pool of solutions from the quantum annealer comprise energy states that are converted to solutions.

15. The non-transitory storage medium of claim 12, further comprising selecting the patterns from a reduced pool of solutions, wherein the pool of solutions is reduced based on solution cost value or energy level or wherein the pool of solutions is reduced using Maximal frequent patterns.

16. The non-transitory storage medium of claim 11, further comprising reducing a number of the patterns based on a minimum support value or by mining maximum frequent patterns.

17. The non-transitory storage medium of claim 11, wherein the classical solver comprises a heuristic solver.

18. The non-transitory storage medium of claim 17, further comprising removing certain solution parts from the patterns.

19. The non-transitory storage medium of claim 11, wherein the classical solver comprises an exact solver.

20. The non-transitory storage medium of claim 19, further comprising fixing decision variables in the patterns such that search is focused on solution parts that are not present in the patterns.
